(19) United States
(12) Patent Application Publication
(10) Pub. No.: US 2025/0307338 A1
(43) Pub. Date: Oct. 2, 2025

(54) LANDING PAGES WITH PREDICTIVE ANALYTICS

(71) Applicant: Reed Automotive Group, Inc., Saint Joseph, MO (US)

(72) Inventors: Larry G. BROWN, JR., Overland park, KS (US); Tyler William REED, Platte City, MO (US); Jacob VAUPELL, Overland park, KS (US)

(21) Appl. No.: 19/095,890

(22) Filed: Mar. 31, 2025

Related U.S. Application Data
(60) Provisional application No. 63/572,712, filed on Apr. 1, 2024.
(60) Provisional application No. 63/572,769, filed on Apr. 1, 2024.

(51) Int. Cl. G06F 16/958; H04L 67/50

(52) U.S. Cl. CPC G06F 16/958; H04L 67/535

(57) ABSTRACT

Systems and methods are provided for generating landing pages with predictive analytics. A client can customize data inputs to generate a dynamic landing page for a customer such that a primary filter can be applied to a set of results. The dynamic landing page can be an intermediate application separate from a destination web site. The client can add a plurality of layers of filters to be applied by the generator, separate from the destination web site, before the user is navigated to the destination web site associated with the client.

### CROSS-REFERENCE TO RELATED APPLICATIONS

This application claims the benefit of U.S. Provisional Application No. 63/572,712, filed on Apr. 1, 2024, and U.S. Provisional Application No. 63/572,769, filed on Apr. 1, 2024. The aforementioned applications are incorporated herein by reference in their entirety.

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

In aspects set forth herein, systems and methods are provided for providing dynamic landing pages customized to a user's intent utilizing an intermediary application (i.e., generator) that dynamically generates custom landing pages. More particularly, in aspects set forth herein, systems and methods enable a landing page generator that can generate customized landing pages for a plurality of users with custom data integrated therein.

### BRIEF DESCRIPTION OF THE SEVERAL VIEWS OF THE DRAWINGS

Illustrative aspects of the present disclosure are described in detail below with reference to the attached drawing figures, wherein:

FIG. 1 depicts a diagram of an exemplary network framework in which implementations of one or more aspects of the present disclosure may be employed, in accordance with aspects herein;

FIG. 2 depicts a diagram of an exemplary network framework in which implementations of one or more aspects of the present disclosure may be employed, in accordance with aspects herein;

FIGS. 3-8 depict illustrative screen shots of landing page generation, in accordance with aspects herein;

FIGS. 9-12 depict illustrative screen shots of an example landing page, in accordance with aspects herein;

FIG. 13 depicts an illustrative screen shot of an external destination page, in accordance with aspects herein;

FIG. 14 depicts an illustrative screen shot of an example heat map, in accordance with aspects herein;

FIG. 15 provides an example flow diagram, in accordance with aspects herein; and

FIG. 16 depicts a block diagram of an exemplary computing device suitable for use in implementations of one or more embodiments of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present technology may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media.

Computer-readable media include both volatile and nonvolatile media, removable and non-removable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions-including data structures and program modules-in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

Aspects herein provide for dynamically generating landing pages. In a first aspect, a system is provided. The system comprises one or more processors; and one or more computer-readable media storing computer-usable instructions that, when executed by the one or more processors, cause the one or more processors to: identify one or more filter criteria for a primary landing page, wherein the primary landing page is an application hosted web page separate from a destination web page; generate the primary landing page comprising at least one primary filter selector based on the one or more filter criteria; receive one or more selections of the primary filter selector; and switch from the application hosted web page to the destination web page such that the user is navigated to the destination web page.

In another aspect, a method is provided for dynamically generating a landing page. The method comprises identifying one or more filter criteria for a primary landing page, wherein the primary landing page is an application hosted web page separate from a destination web page; generating the primary landing page comprising at least one primary filter selector based on the one or more filter criteria; receiving one or more selections of the primary filter selector; and switching from the application hosted web page to the destination web page such that the user is navigated to the destination web page.

In yet another aspect, computer-readable storage media having computer-executable instructions embodied thereon is provided that, when executed by one or more processors, cause the processors to perform a method. The method comprises identifying one or more filter criteria for a primary landing page, wherein the primary landing page is an application hosted web page separate from a destination web page; generating the primary landing page comprising at least one primary filter selector based on the one or more filter criteria; receiving one or more selections of the primary filter selector; and switching from the application hosted web page to the destination web page such that the user is navigated to the destination web page.

By way of background, users/consumers have been the subject of advertising campaigns for many years. Most people receive advertisements in various forms, such as electronic mail messages, text messages, social media ads, and the like. Generally, when a consumer clicks on an advertisement, they are directed to a generic landing page that is the same for all users. For instance, if a user clicks on an automobile advertisement, they are generally navigated to an automobile dealership home page. Or, by way of further example, if a user clicks an advertisement for new car deals, they may be navigated to a landing page of all new cars. At that point, users are required to either sift through hundreds of results, many of which are not relevant to their needs, or manually apply filters (e.g., new or used cars, vehicle manufacturers, vehicle models, model years, mileage limitations, price limitations, etc.) to the results to narrow down the results or navigate to a page that is better targeted to their needs.

The present disclosure seeks to provide a mechanism that alleviates the frustrations of the consumer by dynamically generating custom landing pages with only a few inputs from a user wherein the options are provided to the user in an easily digestible, user-friendly, easily navigable intermediary user interface. In short, a generator acts an intermediary application to both monitor a user's actions to better understand the needs of consumers and navigate a user to a dynamic landing page that is customized to the user's specifications.

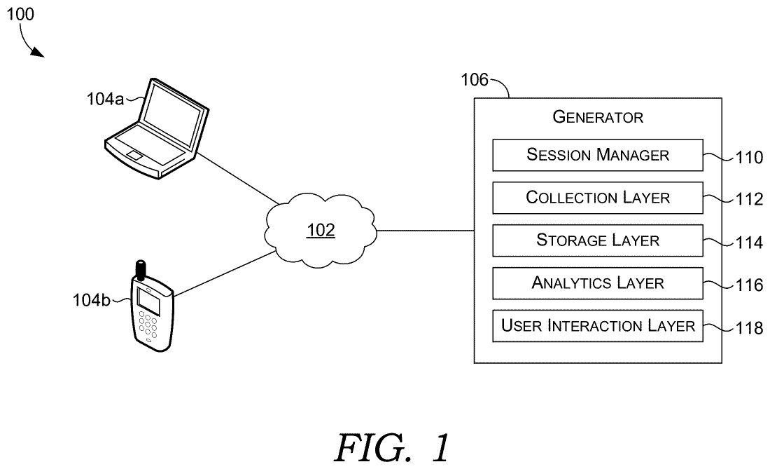

Turning to FIG. 1, a network environment suitable for use in implementing embodiments of the present disclosure is provided. Such a network environment is illustrated and designated generally as network environment 100. Network environment 100 is but one example of a suitable network environment and is not intended to suggest any limitation as to the scope of use or functionality of the disclosure. Neither should the network environment 100 be interpreted as having any dependency or requirement relating to any one or combination of components illustrated.

A network may comprise a network 102, one or more user devices shown as user devices 104a and 104b, and a generator 106. In the network environment 100, components thereof may communicate with other devices, such as mobile devices, servers, etc. The other devices, such as user devices 104a and 104b, may take on a variety of forms, such as a personal computer, a laptop computer, a tablet, a netbook, a mobile phone, a smart phone, a personal digital assistant, or any other device capable of communicating with other devices. For example, the network environment 100 can comprise devices that may take on any form such as, for example, a mobile device or any other computing device capable of communication with the other devices. A device can include, for example, a display(s), a power source(s) (e.g., a battery), a data store(s), a speaker(s), memory, a buffer(s), and the like. The generator 106 can be an intermediary application that presents information to a user, via the user devices 104a or 104b, to customize a landing page prior to navigating the user to the final destination.

As previously mentioned, without the present generator 106 (i.e., intermediate application), users responding to advertisements, targeted communication, etc., may be generally directed to a similar landing page as one another, regarding of the specific interests of the user. Without the intermediate application/generator, a client is not aware of the specific interests of a user and cannot intelligently navigate the user to relevant information. This is especially important in order to convert clicks into monetized opportunities. While applicable to many industries, discussion herein may focus on automobile industry examples for clarity. However, this is not meant to limit the scope of the present disclosure and the generator 106 described herein may be configured to adapt to any industry such as, but not limited to, automobile sales, services, furniture, recreational vehicle transactions, online grocery applications, apparel, transportation, etc.

The generator 106 can include a session manager 110, a collection layer 112, a storage layer 114, an analytics layer 116, and a user interaction layer 118. In aspects, the network environment 100 can operate as a cloud-based service. Any cloud-based image and video management service can be utilized to facilitate image and video management so that users can upload, store, manage, and deliver images and videos for websites, applications, and the like. Additionally, various databases described herein may be proprietary and not accessible to clients, only to the network environment 100. In aspects, the network environment 100 utilizes a headless content management system (CMS) hosted on a cloud-based platform connected to a database, for managing content, storing vehicle models and customer data, and serving as an internal CMS.

If utilizing an example from the beginning, a trigger for the example process may be a user interaction with promotional content. A user interaction, as used herein, may comprise a user click, a user providing information, and the like. Promotional content as used herein, refers generally to any content distributed to one or more users to incentive user interaction directed to purchasing a product such as, but not limited to, emails, text messages, and the like. The generator 106 is triggered when a user interacts with a promotional content that is associated with the generator 106. Content is associated with the generator 106 when it has been created with unique identifiers routing a user to an intermediary page (e.g., intermediary landing page) instead of a destination page. A destination page, as used herein, refers generally to a web page associated with a domain of the promotional content creator (e.g., a dealer web site of a dealer's ad, a store website for a store flier, etc.). An intermediary page, as used herein, refers generally to a web page presented to a user prior to navigating to a domain associated with the destination page. That is, the intermediary page will include an identifying address (e.g., web address) that is associated with a domain of the generator, not the destination page or the promotional content owner (e.g., owner of the destination page domain).

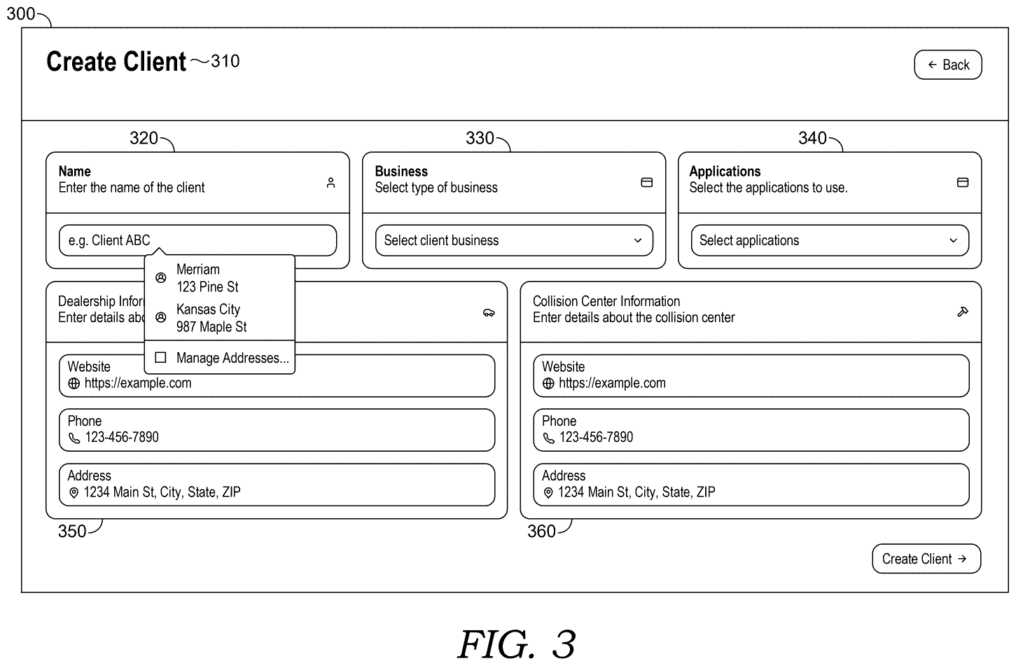

Such association with the generator 106 results from a client of the service described herein configuring a primary page for a user. An example of such configuration is illustrated in FIGS. 3-8. As shown in FIG. 3, an illustrative screen shot 300 is provided comprising a client identifier 310, client information areas 320, 330, 340, 350, and 360. As shown, information such as the name of the client, address, type of business, applications/services to use (e.g., landing page or photo estimator), online information (e.g., web address, phone number, etc.), and collision center information (for the photo estimator application) are obtained. FIG. 3 is the initial configuration for a new client to set up a profile with the generator 106.

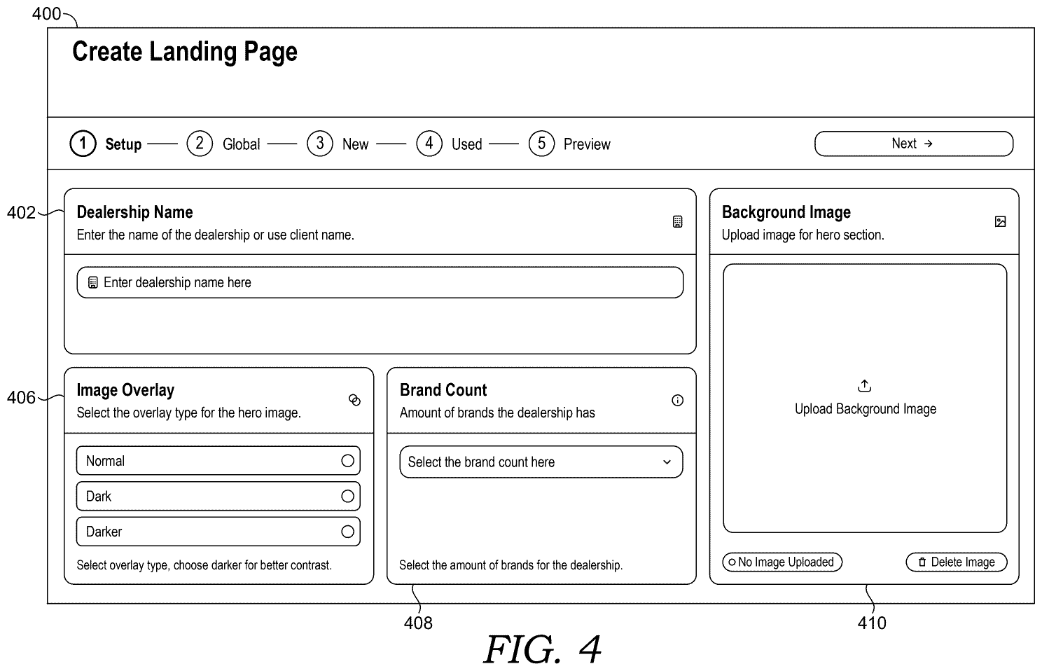

FIG. 4 is an illustrative screen shot 400 of a client creating an intermediary landing page. The name of the entity associated with the intermediary landing page is obtained in area 402. A user also has an option to choose various images to use on the intermediary landing page such as an overlay image at area 406 and a background image at area 410. A brand number is also obtained at brand count area 408 such that a landing page is appropriately configured based on a number of brands offered. For instance, a page can be laid out differently if presented two categories of information versus if presenting 20 categories of information.

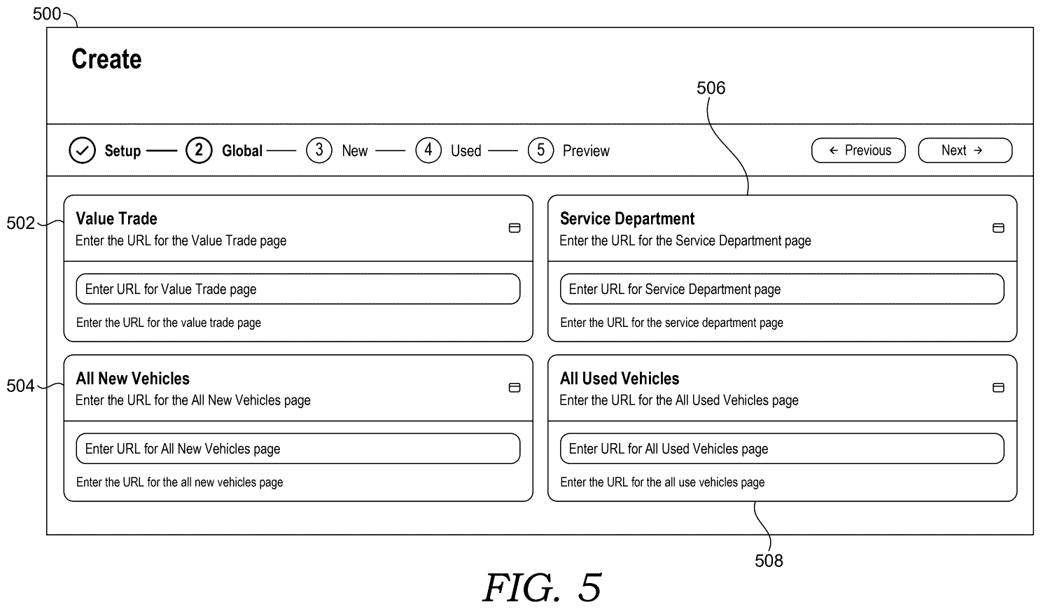

FIG. 5 is an illustrative screen shot 500 of a client creating the landing page itself. This screen shot 500 is a top-level hierarchy for clients to break down their offerings. For instance, in the example of a car dealer, their inventory/services can immediately be broken down into new and used. Service is usually also offered at a car dealership so that may be included along with a photo estimator for a collision center (if offered) and a trade value estimator. The uniform resource locator (URL) for any service offerings for the client can be entered at screen shot 500. As shown, the trade value estimator URL can be input into area 502 while the new vehicle URL is provided in area 504 and the used vehicle URL is provided in area 508. A service department URL is provided in area 506, if applicable. A section can also be added for a photo estimator/collision center service if applicable.

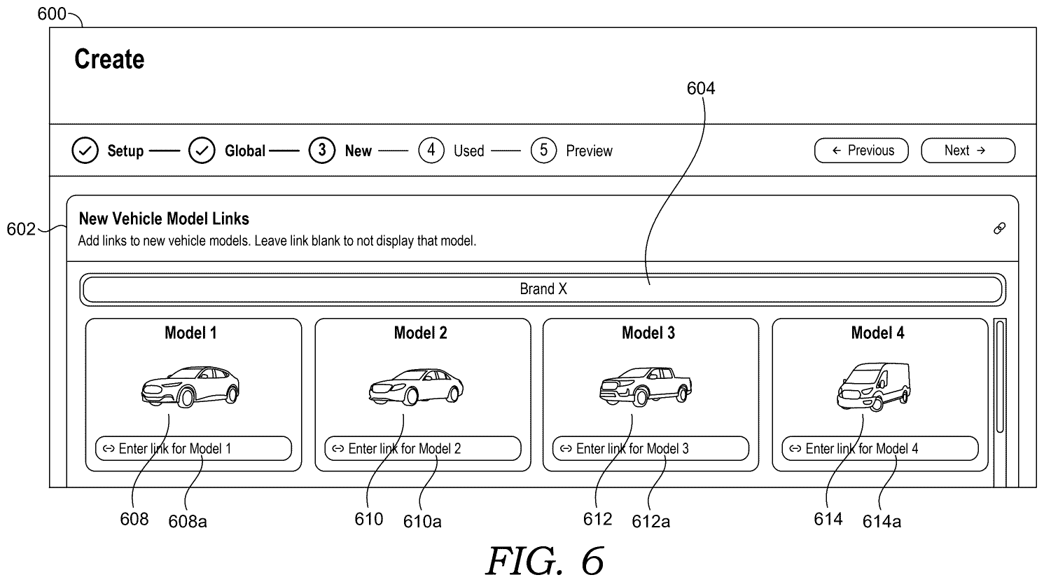

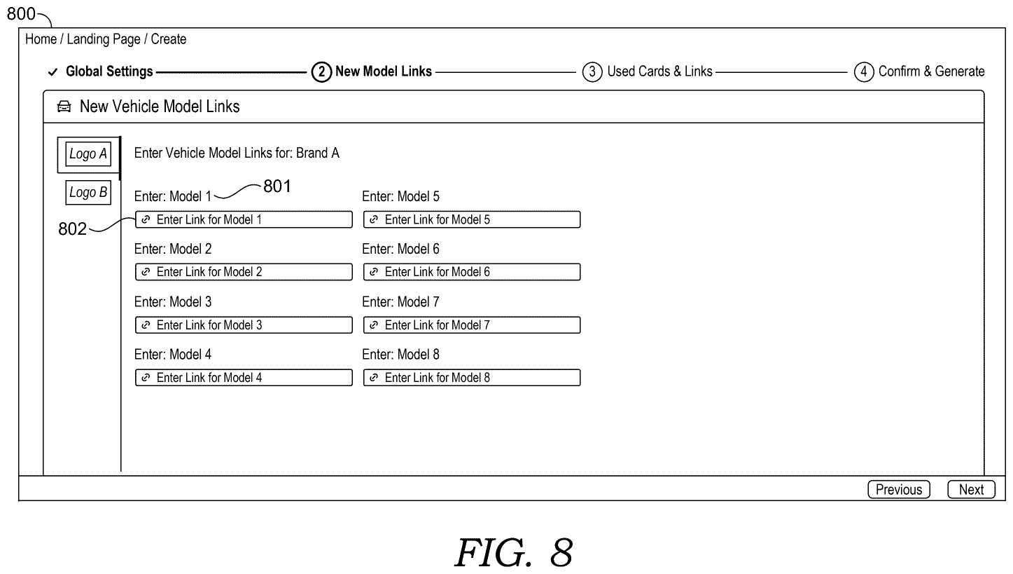

FIG. 6 is an illustrative screen shot 600 further breaking down the hierarchy of offerings for the client. As shown, screen shot 600 is gathering the URL information for specific brands that may be found on a new vehicle URL (previously provided in screen shot 500). Example Model 1 is illustrated in card 608 along with a URL for Model 1 at area 608a. As shown, each model found on the new vehicle URL can be provided in a model card, such as cards 608, 610, 612, and 614. Each model card can include a specific URL for a page having only new vehicles of that model. Similarly, FIG. 8 is an illustrative screen shot 800 of an alternative entry method such that a model list is provide including one or more vehicle models for a specific make selected (rather than the cards shown above). Similarly, a model identifier 801 is listed along with an area 802 to input a unique URL link to the specific model associated with the model identifier 801.

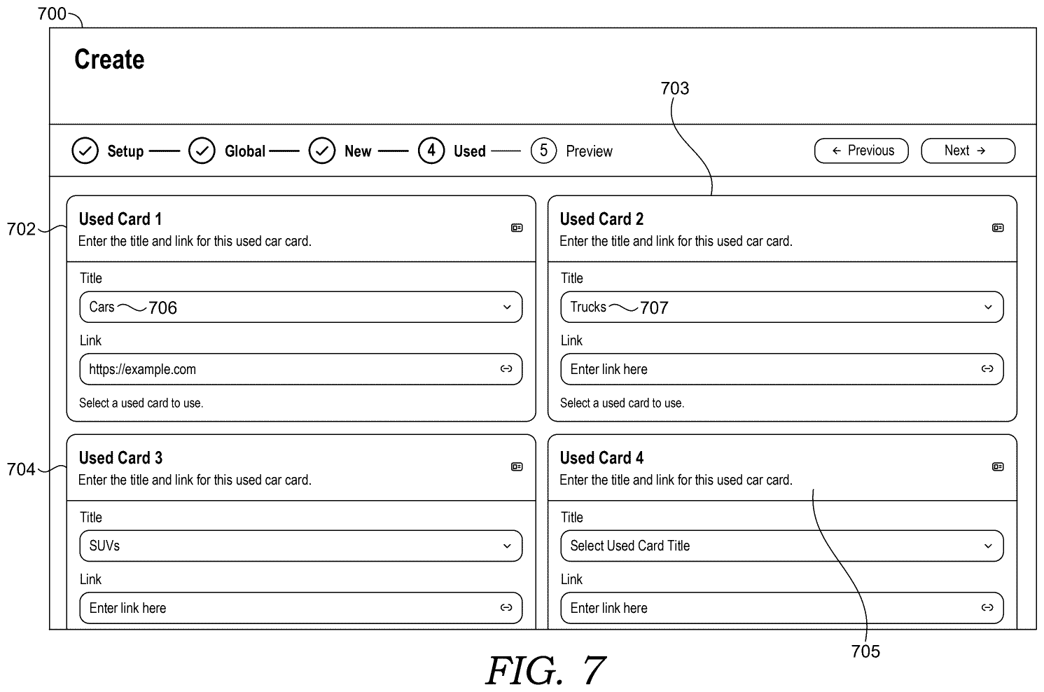

Continuing on, FIG. 7 is an illustrative screen shot 700 gathering similar information but for used cars. These may be categorized out by a type of vehicle such as cars, trucks, vans, SUVs, etc. As shown, a card 702 is utilized to input information for a car-type 706 used vehicle with a specific link provided while another card 703 is utilized to input information for a truck-type 707 used vehicle. Similarly, cards 704 and 705 are also shown to collect other address information for other vehicle types.

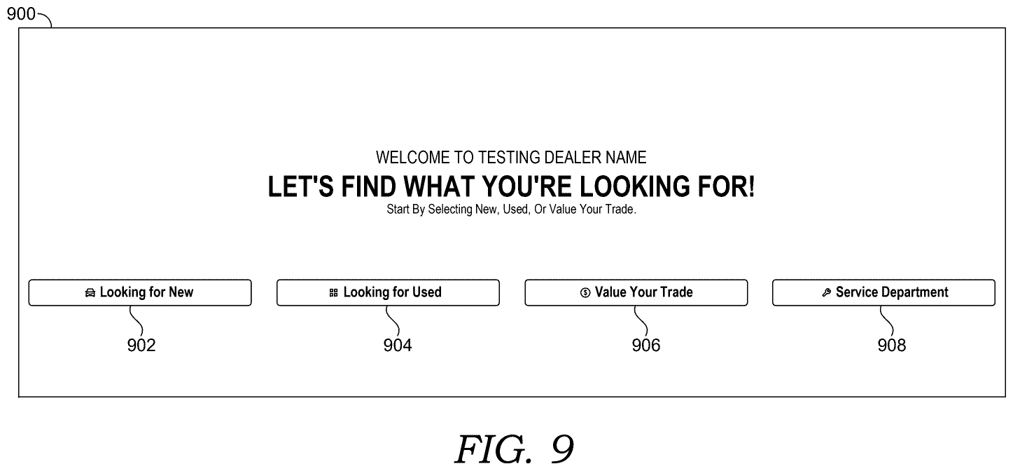

The input information described above is associated with a client and stored by the generator 106 for use in the dynamic sessions and generation of landing pages for users. An example landing page (e.g., intermediary page, intermediary landing page, etc.), is provided in FIG. 9 as an illustrative screen shot 900. A selected background image can be presented in the landing page along with one or more primary selectable filters, shown as selectable filters 902, 904, 906, and 908. As stated earlier, a car dealership is utilized herein for example purposes, but the technology described herein is applicable to any industry. It should be appreciated that the generator 106 generates the landing page screen shot 900 as an intermediate page crafted by the generator and separate from a destination web page. For instance, the location of the intermediate page may be associated with an identifier that links it to the intermediate application (i.e., the 106) such generator as https://www.intermediatelandingpageapplicationexampleaddress, etc. rather than https://www.dealerpageexampleaddress for an actual dealer website).

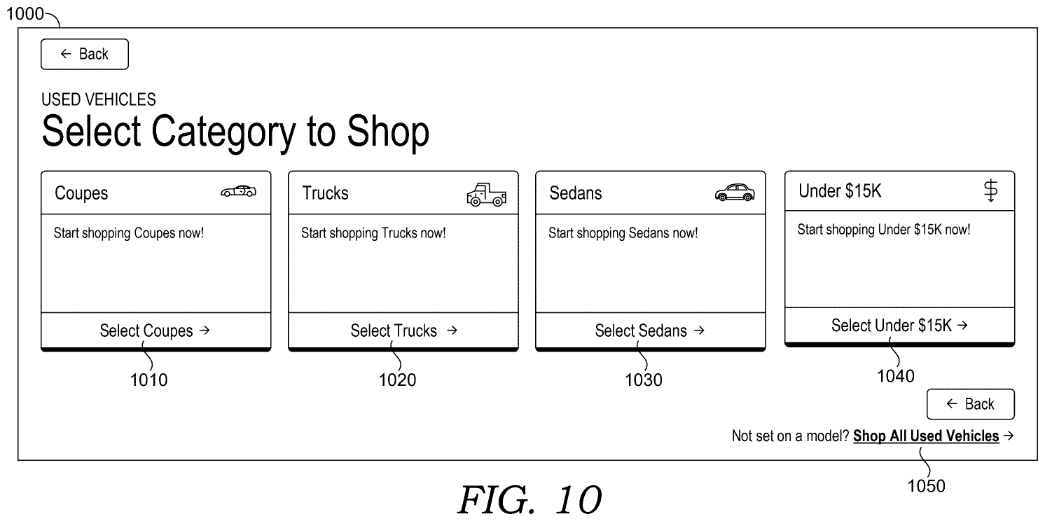

Once on the intermediate landing page, the entered data can be utilized to generate dynamic pages for the user to navigate. For instance, should a user select selectable filter 904 (i.e., used cars) from the landing page screen shot 900, a next illustrative screen shot 1000, shown in FIG. 10, may be generated to provide one or more categories for the used selection. Categories can be any type of thing/service that are a next level of hierarchy. For instance, in used cars, a next level category may be a type of car, such as truck, car, van, SUV, etc. In furniture, a next level category may be kitchen, living room, bedroom, etc. and a next level after a living room selection may be coffee tables, end tables, couches, love seats, accent chairs, sectionals, tv tables, etc. The screen shot 1000 includes category cards 1010, 1020, 1030, and 1040, each associated with a next level category of used vehicles. Should a user desire to not further limit the search (i.e., they want to view all used vehicles), then they can select an open filter at link 1050 to view all items associated with their previous selection without any additional filters applied (i.e., all used vehicles without designating a type of vehicle).

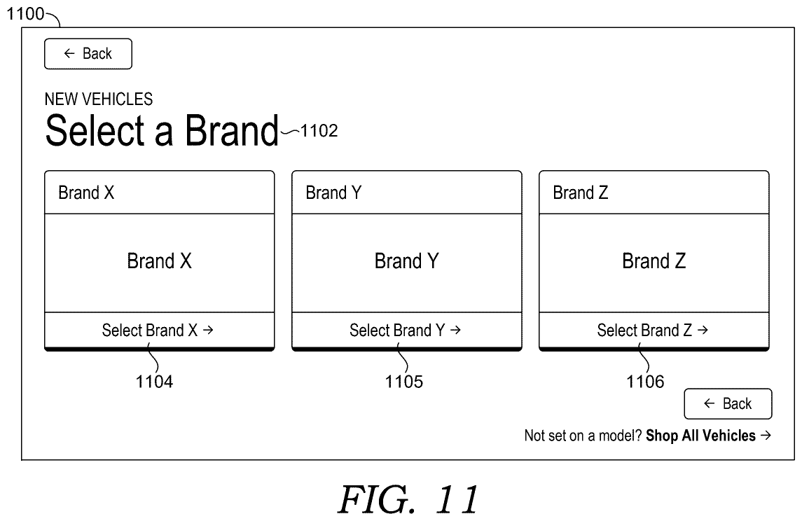

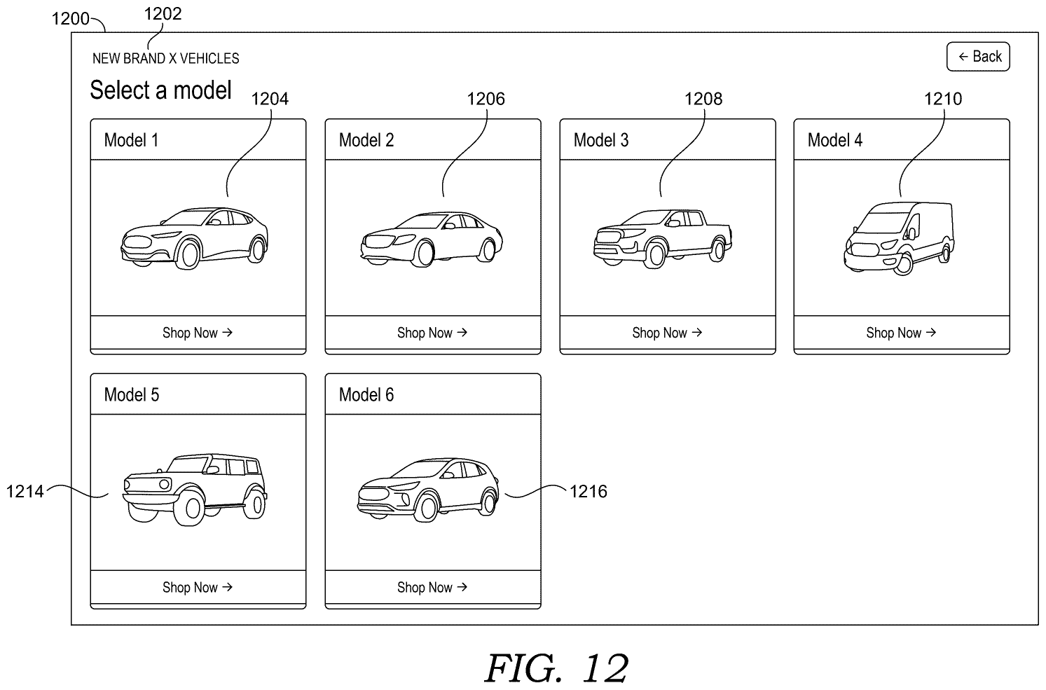

As an additional example, assume a user selects selectable filter 902 (i.e., new vehicles) from landing page screen shot 900. Such a selection would navigate to a next intermediate page (similar to that shown in FIG. 10) illustrated as an illustrative screen shot 1100 shown in FIG. 11. This example provides a next level category for new vehicles as a brand (e.g., make of the vehicle). Multiple category cards shown as category cards 1104, 1105, and 1106 are provided in screen shot 1100, each associated with a different vehicle manufacturer. Should a user select one of the brands, for example, Brand X from category card 1104 (shown as selected brand 1202), a next illustrative screen shot 1200 would be presented and is provided in FIG. 12. As can be imagined, a next level category from a vehicle make is a vehicle model. Category cards in FIG. 12 are, thus, each associated with different vehicle models that are associated with the selected make (e.g., Brand X). As such, category cards 1204, 1206, 1208, 1210, 1214, and 1216 are each associated with a vehicle model. With each of the above screens, a user can select to view all results of their previous selection without applying additional filters.

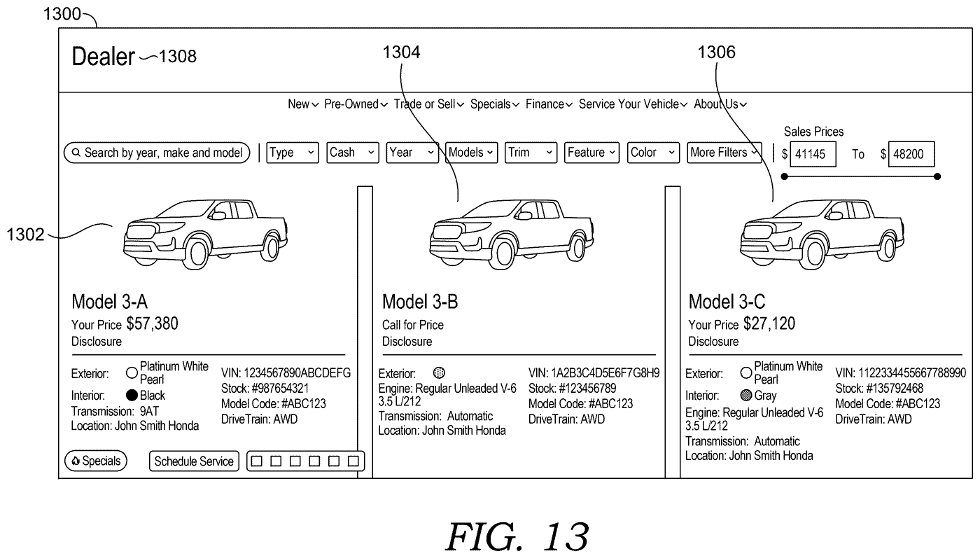

The generator 106 can break down navigation with a configurable amount of next level categories. For example, the car dealership example mentioned above started with a new v used category, then a vehicle make, a vehicle model as filters. A type of vehicle could be added, as well as any other filters such as mileage, price, etc. Once the generator has navigated through all input categories, the user is then directed to a destination web page that corresponds to the last filter applied to the results in the intermediary landing pages. For instance, should a user select one of the category cards of FIG. 12 indicating a vehicle model (e.g., Model 3 at category card 1208), and that was the last provided filter by a client when configuring their landing pages, then the generator 106 would navigate the user to an external location of a destination web page that corresponds to the Model 3 selection on the client's web page. Thus, the user is switched from an intermediate application hosted by the generated 106 to an external web page hosted by the client, not the generator 106. An example of such a destination web page is shown at illustrative screen shot 1300 of FIG. 13. As shown, the destination web page comprises a source identifier 1301 shown as a label on this example screen shot but may also be a unique URL associated with the client domain, not the domain of the intermediary application (i.e., generator 106). All available models that match the user's selections are provided on the page 1300 an individually selectable models, shown as model 1302, model 1304, and model 1306. This allows a user to easily indicate the information desired and be quickly navigated to an external web page including the corresponding information. In industries with so many products, such as vehicles, furniture, etc., web sites can be overwhelming for users and difficult to navigate from the sheer volume of information available.

Returning now to FIG. 1, the generator 106 is configured to perform all of the backend landing page generator described above as well as monitoring user activity after generation of the landing page. The session manager 110, for instance, is configured to determine whether the session is new or existing. This can be determined by identifying stored cookies associated with the landing page (e.g., cookies can be configured to delete within an hour). If there is a cookie present, the session can be validated (a new session is not created). If not present, a new session can be initiated. Once initiated or validated, user information is collected by the collection layer 112. This can include page data, user data, device data, etc. This can all be stored by/at the storage layer 114 as well as the analytics layer 116. The analytics layer 116 can be a relational database management system for storing and managing structured data.

The user interaction layer 118 is configured to collect data related to user actions such as clicks, activity on a page, view time, etc. Click conversions, as used herein, refer generally to a user pattern that includes one or more clicks that resulted in the user being navigated to the external destination page. A standard click, as used herein, refers generally to a user pattern that includes one or more clicks that do not result in the user being navigated to the external destination page. That is, the user clicked, but remained on the intermediary landing pages (e.g., clicks on looking for new but no further, etc.).

Thus, the generator 106 may be configured to generate a customizable landing page on behalf of clients. The landing page is created from the generator and is not associated with a destination web site. For instance, a user that clicks a new vehicle sale advertisement for Dealer X can be navigated to the intermediate landing page provided by the generator 106 such that the interests of the user relevant to the destination web site are captured but the user is not yet connected to the destination web site. The generator 106 can also track analytics to capture activity of a customer while navigating the landing pages.

In order to generate the dynamic landing pages, the generator 106 has access to inventory information for clients. This information was discussed above with respect to FIGS. 3-8. Since a plurality of different clients and, as a result, different data is possible to use with the generator 106, the network environment 100 described herein is scalable and can be a multi-tenant system. As such, each separate client could be organized within a separate domain within a primary domain of the generator and multiple domains can be added to the generator. Additionally, clients can input destination web pages to be associated with one or more search filters. The data is managed in the network environment 100.

In aspects, a primary landing page presented to a user from the generator 106 will comprise a destination identifier (e.g., a name of an entity associated with a destination web site, a web address, etc.) and at least one primary search filter. For example, a primary search filter for an automotive landing page may include new cars or used cars. A primary search filter could also be a trade in valuation tool, a service scheduler, a photo estimator for collision services, and the like. Upon selection of a primary search filter, the generator navigates the user to at least two category cards. A category card, as used herein, refers to a filter that elects or omits at least a set of hits from a repository of results (e.g., a database). Example category cards, as previously discussed, may include a vehicle manufacturer, a vehicle model, a type of vehicle (e.g., trucks, sedans, SUVs, etc.), and the like. Upon selection of a category card, a next screen may be provided with additional category cards that further filter the initial selection(s). For instance, if a user picks “new vehicles” they may be navigated to a set of category cards that include Manufacturer A, Manufacturer B, Manufacturer C, and the like. Upon selection of Manufacturer B, the user may then be navigated to a next screen that includes a set of category cards of models of cards associated with Manufacturer B, such as Model 1, Model, 2, Model 3, and the like. Selection of a model, such as Model 3, will then navigate the user to a search results page including one or more results that match the selected criteria (i.e., manufacturer and model in this example). At this point, or any other point along the selection process, a client can configure the generator to navigate to a destination page associated with the client web site such that the application associated with the generator 106 is no longer hosting the viewed page and the user is delivered to a desired portion of the client's web site that is not hosted by the generator 106. In other words, the user is switched from the intermediate application to the destination web site host based on customizable configurations by the client.

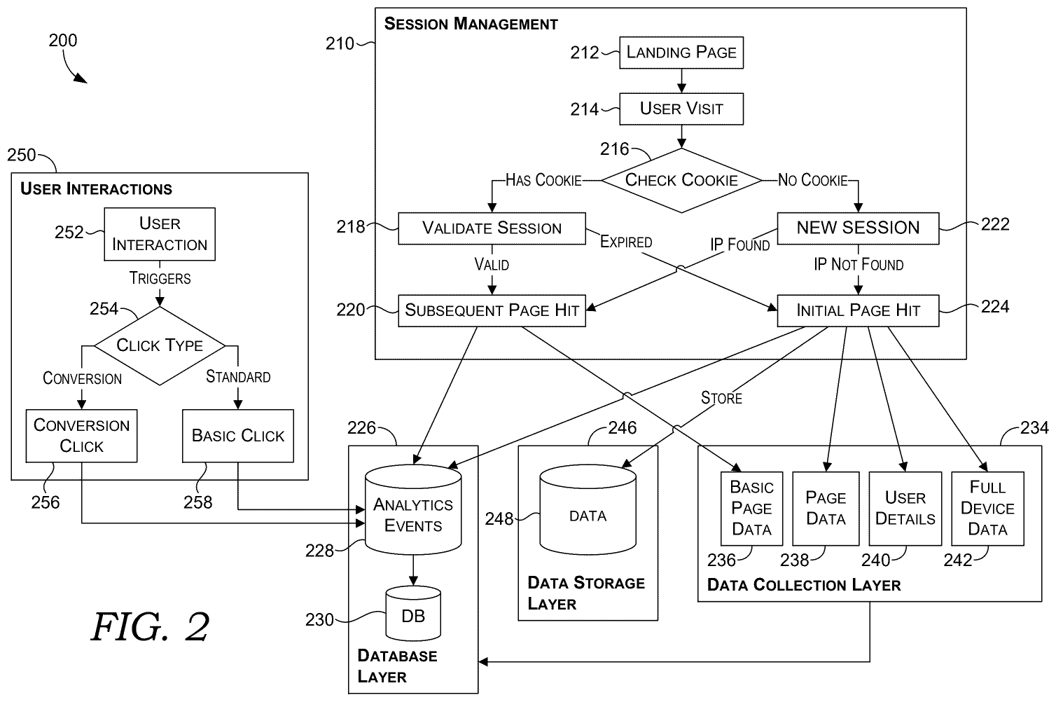

FIG. 2 provides an example flow diagram 200 of the generator activity. Session management control is illustrated at block 210. Initially, when a user visits a landing page at block 212, a visit is identified at block 214. A determination is made whether the visit is new or existing (i.e., an existing session or a new session) at block 216 by checking a cache for a session identifier (e.g., cookie). If a cookie is present, the session is validated at block 218. Cookies can be configured to remain in cache for a predetermined period of time (e.g., an hour) such that a cookie may be detected but it may be expired. In the event the cookie is valid, the existing validated session is logged as a subsequent page hit at block 220. A subsequent page hit is a hit/visit to a landing page from a user that has previously, within a predetermined period of time, visited the same landing page. If the cookie is expired, the hit is logged as an initial page hit, which is a hit/visit to a landing page from a user that has not visited the landing page within a predetermined period of time. Similarly, if no cookie is present, a new session is established at block 222 and logged as an initial page hit at block 224.

Session data is then stored at the data collection layer 234. If the session is a new session, more data is stored since it does not exist for the user yet (i.e., if it is a new session then the user has not previously visited the landing page). Such data can include basic page data 236 (e.g., URL, section information), page data 238 (e.g., URL path, initial section information), user details 240 (e.g., time zone, language, internet protocol address, geographical data (e.g., location)), and device data 242 (e.g., hardware: type of device, memory of device, etc.). The data (or at least a portion thereof) can be stored at the data storage layer 246 at database 248. The data collection layer 234 can also share data with the analytics layer 226. Analytics events can be stored in the analytics databases 228 and 230. The analytics layer 226 can determine how a user interacts with the landing pages such as standard clicks, click conversions, time of day a particular user visits, time of day a region of a group of users visits, types of data a group of users views (e.g., a zip code), and the like. This analytical analysis can be utilized by clients to target advertisements to increase click conversions. For instance, if a subset of users is identified by the analytics layer 226 to only click promotional content from emails and not text messages, any subsequent text message campaign can be cancelled. In particular, the analytics layer 226 can recommend that text message campaigns to particular users be suspended. By way of further example, the analytics layer 226 can determine that users over a predetermined age only engage with promotional content at a certain time of day. The analytics layer 226 could recommend that promotional content be sent at a specific time of day right before the users typically engage so that it is fresh content. In aspects, the analytics layer 226 could automatically push promotional content to specific users based on the analytical data. This analytical data may be gleaned in partnership with the user interactions layer 250. Click types are determined at block 254 and categorized as either a click conversion at block 256 or a standard click at block 258. This information is all shared with the analytics layer 226.

In additional to creation of the landing pages, the generator 106 is also configured to track user activity, as previously discussed with respect to the user interactions layer 250 and the analytics layer 226. A number of clicks, paths taken, time spent on a page, and the like, are examples of data that the generator 106 tracks. In addition to tracking, the generator 106 can also record user activity (e.g., clicks, hovers, time for each activity, etc.) and build internal demographics based on the users that come through the generator 106. Zip codes, for instance, may be identified to create a demographic. Additional information that can be obtained includes name, IP address, age, address, location, device used, time of day, headers, type of browser, etc. This information may be tracked and certain data compliance guidelines may be applicable.

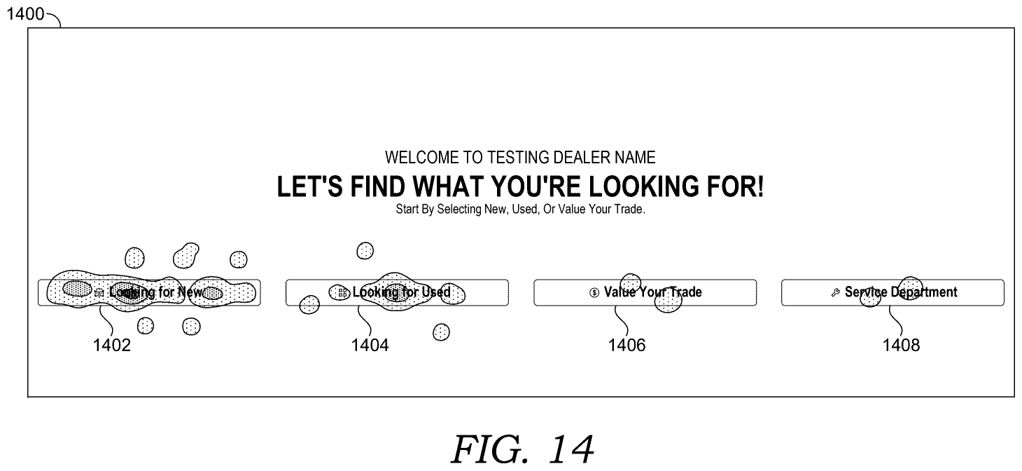

The generator 106 can organize the tracking information to generate a dynamic heat map as shown in illustrative screen shot 1400 of FIG. 14. The heat map can provide information on a number of clicks users made to a particular selectable icon on a page, areas of interest of a page (e.g., hover activity is increased), etc. The heat map may be generated as an overlay to the relevant web page. For instance, if the initial landing page is being evaluated, the initial landing page would be generated and a heat map overlay would be superimposed on top of the initial landing page so that a user can easily and quickly identify areas of the landing page to which the heat map data pertains (as is shown in FIG. 14). Additionally, recordings can also be displayed to a user as an overlay to the relevant page.

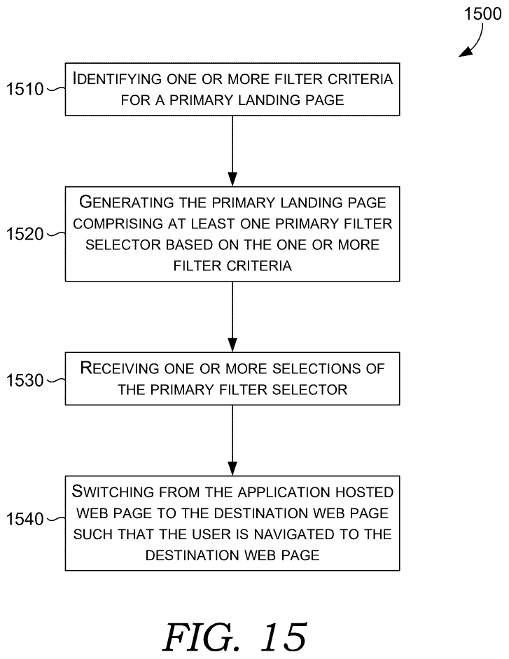

FIG. 15 is an example flow diagram 1500 of an aspect herein. Initially, at block 1510, one or more filter criteria is identified for a primary landing page. The primary landing page can be an application-hosted web page separate from a destination web page (i.e., hosted by an entity different than that hosting primary landing page). At block 1520, the primary landing page is generated comprising at least one primary filter selector based on the one or more filter criteria. One or more selections of the primary filter selector is received at block 1530. At block 1540, a switch is made from the application-hosted web page to the destination web page such that the user is navigated to the destination web page.

While the description above has focused on procurement of a vehicle, additional aspects relate to collision repair of a current vehicle. Similar to vehicle shopping, collision repair is a cumbersome process that is sometimes overwhelming for users in large part because of the association with a car dealership website, which are known for difficult navigability. As with the above aspects, a user can be navigated to a collision estimator/photo estimator tool, separate from a destination web page (e.g., collision center web site) in order to input information. An intermediate form can be provided by the generator 106 that intakes information from the potential customer (e.g., name, address, make/model of vehicle, description of damage, insurance provider, etc.) such that the requirements of any destination location are captured but the user is not yet connected to the destination location. The generator 106 can navigate a user to the destination location, along with the pre-input information, for submission. In aspects, the generator 106 may be able to distribute the input information to a plurality of destination locations such that a user can input their information into the intermediary landing page for the collision estimator a single time, but the information is disseminated to a plurality of destination locations (e.g., multiple collision centers) to obtain multiple bids.

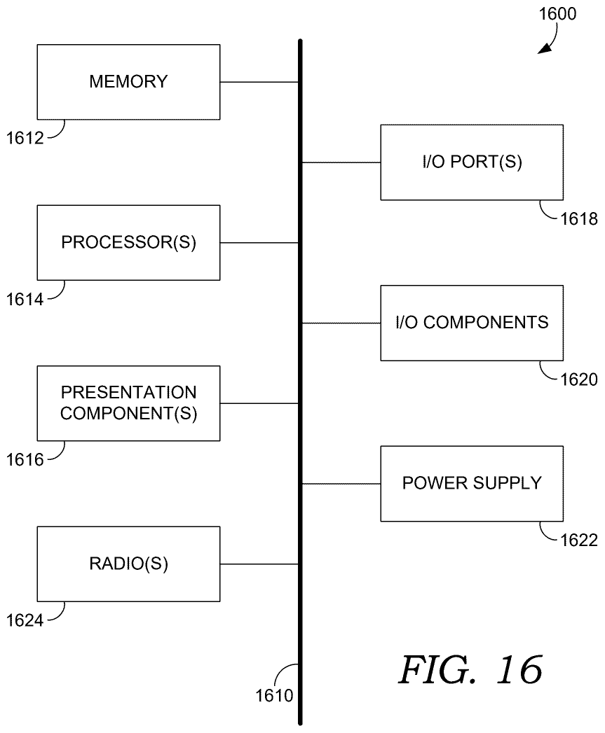

Referring now to FIG. 16, a block diagram of an example computing device 1600 suitable for use in implementations of the technology described herein is provided. In particular, the exemplary computer environment is shown and designated generally as computing device 1600. Computing device 1600 is but one example of a suitable computing environment and is not intended to suggest any limitation as to the scope of use or functionality of the invention. Neither should computing device 1600 be interpreted as having any dependency or requirement relating to any one or combination of components illustrated. It should be noted that although some components in FIG. 15 are shown in the singular, they may be plural. For example, the computing device 1600 might include multiple processors or multiple radios. In aspects, the computing device 1600 may be a UE/WCD, or other user device, capable of two-way wireless communications with an access point. Some non-limiting examples of the computing device 1600 include a cell phone, tablet, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

As shown in FIG. 16, computing device 1600 includes a bus 1610 that directly or indirectly couples various components together, including memory 1612, processor(s) 1614, presentation component(s) 1616 (if applicable), radio(s) 1624, input/output (I/O) port(s) 1618, input/output (I/O) component(s) 1620, and power supply(s) 1622. Although the components of FIG. 16 are shown with lines for the sake of clarity, in reality, delineating various components is not so clear, and metaphorically, the lines would more accurately be grey and fuzzy. For example, one may consider a presentation component such as a display device to be one of I/O components 1620. Also, processors, such as one or more processors 1614, have memory. The present disclosure hereof recognizes that such is the nature of the art, and reiterates that FIG. 16 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of the present disclosure and refer to “computer” or “computing device.”

Memory 1612 may take the form of memory components described herein. Thus, further elaboration will not be provided here, but it should be noted that memory 1612 may include any type of tangible medium that is capable of storing information, such as a database. A database may be any collection of records, data, and/or information. In one embodiment, memory 1612 may include a set of embodied computer-executable instructions that, when executed, facilitate various functions or elements disclosed herein. These embodied instructions will variously be referred to as “instructions” or an “application” for short.

Processor 1614 may actually be multiple processors that receive instructions and process them accordingly. Presentation component 1616 may include a display, a speaker, and/or other components that may present information (e.g., a display, a screen, a lamp (LED), a graphical user interface (GUI), and/or even lighted keyboards) through visual, auditory, and/or other tactile cues.

Radio 1624 represents a radio that facilitates communication with a wireless telecommunications network. Illustrative wireless telecommunications technologies include CDMA, GPRS, TDMA, GSM, and the like. Radio 1624 might additionally or alternatively facilitate other types of wireless communications including Wi-Fi, WiMAX, LTE, 3G, 4G, LTE, mMIMO/5G, NR, VOLTE, or other VoIP communications. As can be appreciated, in various embodiments, radio 1624 can be configured to support multiple technologies and/or multiple radios can be utilized to support multiple technologies. A wireless telecommunications network might include an array of devices, which are not shown so as to not obscure more relevant aspects of the invention.

The input/output (I/O) ports 1618 may take a variety of forms. Exemplary I/O ports may include a USB jack, a stereo jack, an infrared port, a firewire port, other proprietary communications ports, and the like. Input/output (I/O) components 1620 may comprise keyboards, microphones, speakers, touchscreens, and/or any other item usable to directly or indirectly input data into the computing device 1600.

Power supply 1622 may include batteries, fuel cells, and/or any other component that may act as a power source to supply power to the computing device 1600 or to other network components, including through one or more electrical connections or couplings. Power supply 1622 may be configured to selectively supply power to different components independently and/or concurrently.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

What is claimed is:

1. A system for dynamic generation of at least one landing page, the system comprising:
one or more processors; and
one or more computer-readable media storing computer-usable instructions that, when executed by the one or more processors, cause the one or more processors to:
identify one or more filter criteria for a primary landing page, wherein the primary landing page is an application hosted web page separate from a destination web page;
generate the primary landing page comprising at least one primary filter selector based on the one or more filter criteria;
receive one or more selections of the primary filter selector; and
switch from the application hosted web page to the destination web page such that a user is navigated to the destination web page.

2. The system of claim 1, wherein the one or more processors generate a heat map of user activity.

3. The system of claim 2, wherein the heat map is an overlay superimposed on the primary landing page.

4. The system of claim 1, wherein the one or more processors generates a recording of user activity.

5. The system of claim 4, wherein the recording of user activity is an overlay of activity superimposed on the primary landing page.

6. The system of claim 1, further comprising determining a group of users to target with promotional content based on historical engagement of promotional content.

7. The system of claim 6, wherein the determining comprises identifying demographic information of a previous group of users that engaged with the promotional content and identifying a current group of users with corresponding demographic information.

8. A method for dynamic generation of at least one landing page, the method comprising:
identifying one or more filter criteria for a primary landing page, wherein the primary landing page is an application hosted web page separate from a destination web page;
generating the primary landing page comprising at least one primary filter selector based on the one or more filter criteria;
receiving one or more selections of the primary filter selector; and
switching from the application hosted web page to the destination web page such that a user is navigated to the destination web page.

9. The method of claim 8, further comprising generating a heat map of user activity.

10. The method of claim 9, wherein the heat map is an overlay superimposed on the primary landing page.

11. The method of claim 8, further comprising generating a recording of user activity.

12. The method of claim 11, wherein the recording of user activity is an overlay of activity superimposed on the primary landing page.

13. The method of claim 11, further comprising determining a group of users to target with promotional content based on historical engagement of promotional content.

14. The method of claim 13, wherein the determining comprises identifying demographic information of a previous group of users that engaged with the promotional content and identifying a current group of users with corresponding demographic information.

15. A non-transitory computer readable media having instructions stored thereon that, when executed by one or more computer processing components, cause one or more computer processing components to perform a method for dynamic generation of at least one landing page, the method comprising:
identifying one or more filter criteria for a primary landing page, wherein the primary landing page is an application hosted web page separate from a destination web page;
generating the primary landing page comprising at least one primary filter selector based on the one or more filter criteria;
receiving one or more selections of the primary filter selector; and
switching from the application hosted web page to the destination web page such that a user is navigated to the destination web page.

16. The media of claim 15, wherein the method further comprises generating a heat map of user activity.

17. The media of claim 16, wherein the heat map is an overlay superimposed on the primary landing page.

18. The media of claim 15, further comprising determining a group of users to target with promotional content based on historical engagement of promotional content.

19. The media of claim 18, wherein the determining comprises identifying demographic information of a previous group of users that engaged with the promotional content and identifying a current group of users with corresponding demographic information.
